(19) United States
(12) Patent Application Publication
(10) Pub. No.: US 2026/0280433 A1
(43) Pub. Date: Sep. 17, 2026

(54) POWER CONVERTER AND CONTROLLING METHOD THEREOF

(71) Applicant: Chicony Power Technology Co., Ltd., New Taipei City (TW)

(72) Inventor: Chen-Chi LIN, New Taipei City (TW)

(21) Appl. No.: 19/239,989

(22) Filed: Jun. 17, 2025

(30) Foreign Application Priority Data
Mar. 17, 2025 (TW) 114109918

(51) Int. Cl. H02M 3/335; H02M 1/00; H02M 1/08

(52) U.S. Cl. CPC H02M 3/33507; H02M 1/007; H02M 1/0093; H02M 1/08

(57) ABSTRACT

A power converter includes a conversion circuit, an auxiliary circuit, and a controller. The conversion circuit includes a changeover switch that adjusts an output voltage based on a first control signal and a magnetic component. The magnetic component includes a primary winding configured to receive an input voltage and a secondary winding configured to provide an output voltage. The primary winding is coupled to the changeover switch. The auxiliary circuit includes an auxiliary winding configured to provide an auxiliary voltage, an energy storage unit configured to store the auxiliary voltage, and a voltage regulation unit to receive the auxiliary voltage and provide an operating voltage. The auxiliary winding is magnetically coupled to the magnetic component, and the voltage regulation unit is coupled to the auxiliary winding and the energy storage unit in parallel. The controller receives the operating voltage from the voltage regulation unit.

### CROSS-REFERENCE TO RELATED APPLICATION

This application claims priority to Taiwan Application Serial Number 114109918, filed Mar. 17, 2025, which is herein incorporated by reference in its entirety.

### BACKGROUND

### Field of Invention

The present disclosure relates to a power converter, and in particular to the power converter capable of controlling a duty ratio of a switch.

### Description of Related Art

A voltage normally supplied to a pulse width modulation controller comes from a voltage mapped from the secondary winding to the auxiliary winding. When a regulated range of an output voltage is extended to 48 volts (V), the voltage mapped back to the controller will also vary over a wide range with the output voltage. At a minimum output voltage of 5V, it should be considered that this voltage is sufficient for the controller. If the controller requires a voltage of 15V (i.e., the number of turns of the secondary winding: the number of turns of the auxiliary winding is 1:3), the range of the output voltage of 5V to 48V mapped back to the auxiliary winding will be from 15V to 144V, which is much higher than the integrated circuit internal withstand voltage. If this voltage is stepped down to 15V through a low dropout regulator (LDO) to the controller, there will be 129V across the LDO, and at the output voltage of 48V, this will result in significant power consumption that will not be able to meet the increasingly stringent energy efficiency regulations. Therefore, how to provide power conversion to solve the above problem is an important issue in this field.

### SUMMARY

A power converter is provided and includes a conversion circuit, an auxiliary circuit, and a controller. The conversion circuit includes a changeover switch that adjusts an output voltage based on a first control signal and a magnetic component. The magnetic component includes a primary winding configured to receive an input voltage and a secondary winding configured to provide an output voltage. The primary winding is coupled to the changeover switch. The auxiliary circuit includes an auxiliary winding configured to provide an auxiliary voltage, an energy storage unit configured to store the auxiliary voltage, and a voltage regulation unit to receive the auxiliary voltage and provide an operating voltage. The auxiliary winding is magnetically coupled to the magnetic component, and the voltage regulation unit is coupled to the auxiliary winding and the energy storage unit in parallel. The controller receives the operating voltage from the voltage regulation unit.

A controlling method of the power converter is provided, in which the power converter includes the conversion circuit having the changeover switch and the magnetic component, the auxiliary circuit having the auxiliary winding, the energy storage unit, and the voltage regulation unit coupled to the auxiliary winding and the energy storage unit in parallel, and the controller. The magnetic component includes the primary side winding and the secondary side winding, in which the controlling method comprises: receiving the input voltage by the primary side winding; adjusting the output voltage based on the first control signal by the changeover switch; providing the output voltage by the secondary side winding; providing, by the auxiliary winding, the auxiliary voltage to the energy storage unit based on one of the input voltage and the output voltage; providing, by the voltage regulation unit, the operating voltage to the controller based on the auxiliary voltage; and obtaining, by the controller, a comparison result of the operating voltage and a rated voltage to adjust a duty ratio of a regulation switch of the voltage regulation unit.

### BRIEF DESCRIPTION OF THE DRAWINGS

The invention can be more fully understood by reading the following detailed description of the embodiment, with reference made to the accompanying drawings as follows:

FIG. 1 illustrates a schematic diagram of a power converter, in accordance with one embodiment of the present disclosure.

FIG. 2 illustrates a flow chart of a controlling method of the power converter of FIG. 1, in accordance with one embodiment of the present disclosure.

FIG. 3 illustrates a controlling timing diagram of the power converter, in accordance with one embodiment of the present disclosure.

FIG. 4 to FIG. 5 illustrate diagrams of operation of the power converter of FIG. 1 during various periods, in accordance with one embodiment of the present disclosure.

FIG. 6 illustrates a controlling timing diagram of the power converter, in accordance with one embodiment of the present disclosure.

FIG. 7 to FIG. 8 illustrate diagrams of operation of the power converter of FIG. 1 during various periods, in accordance with one embodiment of the present disclosure.

FIG. 9 illustrates a schematic diagram of a power converter, in accordance with one embodiment of the present disclosure.

### DETAILED DESCRIPTION

The following provides a detailed description of exemplary embodiments in conjunction with the accompanying drawings. However, the provided embodiments are not intended to limit the scope of the present disclosure. The described structural operations are not intended to constrain their execution sequence. Any structure formed by the recombination of components, resulting in a device with equivalent effects, is within the scope of the present disclosure. Additionally, the drawings are for illustrative purposes only and are not drawn to scale. For ease of understanding, identical or similar components in the following description are indicated by the same reference symbols.

As used herein, the terms “coupled to” or “connected to” may refer to direct physical or electrical contact between two or more components, indirect physical or electrical contact between two or more components, or the interaction or operation of two or more components.

In this document, the term “circuit” broadly refers to an object composed of one or more transistors and/or one or more active or passive components connected in a specific manner to process signals.

In this document, the magnitude of the values mentioned is not intended to limit this disclosure. Various modifications and refinements may be made by those skilled in the art without departing from the spirit and scope of the present disclosure.

The terms used throughout the specification and claims, unless specifically stated otherwise, generally carry their ordinary meanings as understood in the relevant field, as disclosed herein, and within the context of the present disclosure. In addition, the terms “includes,” “including,” “having,” and similar expressions used herein are open-ended terms, meaning “includes but is not limited to.” Furthermore, the term “and/or” used herein includes any one or more of the listed items as well as any and all combinations thereof.

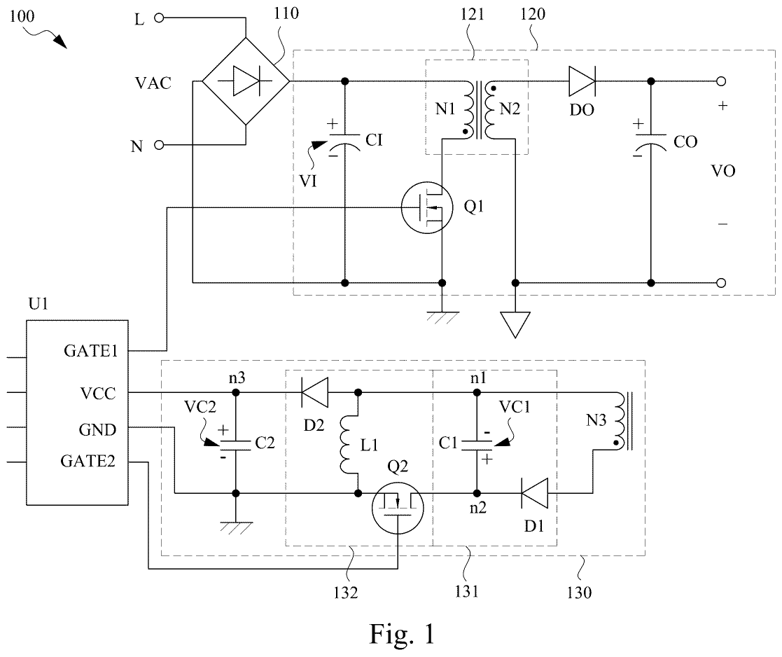

Please refer to FIG. 1. FIG. 1 illustrates a schematic diagram of a power converter 100, in accordance with one embodiment of the present disclosure. As shown in FIG. 1, the power converter 100 includes a bridge rectifier 110, a conversion circuit 120, an auxiliary circuit 130, and a controller U1. In some embodiments, the controller U1 is configured to generate a signal to control operation of the conversion circuit 120 and the auxiliary circuit 130, and can be a microprocessor or any suitable integrated circuits.

In some embodiments, the bridge rectifier 110 is configured to convert an alternating current which enters the power converter 100 into a direct current. The bridge rectifier 110 is coupled between a positive terminal and a negative terminal of an input capacitor CI.

In some embodiments, the conversion circuit 120 includes a magnetic component 121, a changeover switch Q1, the input capacitor CI, an output capacitor CO, and a diode DO. The magnetic component 121 includes a primary side winding N1 and a secondary side winding N2. The changeover switch Q1 is switched on or off in response to a signal Vgs_Q1 received at a gate terminal thereof. A source terminal and a drain terminal of the changeover switch Q1 have a signal Vds_Q1 in response to the signal Vgs_Q1, wherein the signal Vds_Q1 is opposite to the signal Vgs_Q1. The input capacitor CI is coupled between a non-dotted terminal of the primary side winding N1 and a ground terminal. The changeover switch Q1 is coupled between a dotted terminal of the primary side winding N1 and the ground terminal. A dotted terminal of the secondary side winding N2 is coupled to a positive terminal of the diode DO, and a non-dotted terminal of the secondary side winding N2 is coupled to the ground terminal. The output capacitor CO is coupled between a negative terminal of the diode DO and the ground terminal.

In some embodiments, the auxiliary circuit 130 includes an energy storage unit 131, a voltage regulation unit 132, an auxiliary winding N3, and an energy storage capacitor C2. The energy storage unit 131 includes an auxiliary capacitor C1 and an auxiliary diode D1. The voltage regulation unit 132 includes a regulation switch Q2, a regulation diode D2, and a regulation inductor L1. The regulation switch Q2 is switched on or off in response to a signal Vgs_Q2 received at a gate terminal thereof. A dotted terminal of the auxiliary winding N3 is coupled to a positive terminal of the auxiliary diode D1, a negative terminal of the auxiliary diode D1 is coupled to a node n2, and a non-dotted terminal of the auxiliary winding N3 is coupled to a node n1. The auxiliary capacitor C1 is coupled between the node n1 and the node n2. The regulation switch Q2 is coupled between the node n2 and the ground terminal. A positive terminal of the regulation diode D2 is coupled to the node n1, a negative terminal of the regulation diode D2 is coupled to a node n3. The regulation inductor L1 is coupled between the node n1 and the ground terminal. The energy storage capacitor C2 is coupled between the node n3 and the ground terminal.

In some embodiments, a withstand voltage of the changeover switch Q1 is greater than a withstand voltage of the regulation switch Q2.

In some embodiments, the auxiliary winding N3 and the primary side winding N1 are in a same direction (the dotted terminals in the same direction). The auxiliary winding N3 and the secondary side winding N2 are in an opposite direction (the dotted terminals in the opposite direction).

In some embodiments, the auxiliary diode D1, the regulation diode D2, and the diode DO can be replaced by metal oxide semiconductor field effect transistors (MOSFET).

In some embodiments, the controller U1 includes an output signal terminal GATE1, an output signal terminal GATE2, a receiving voltage terminal VCC, and a ground terminal GND. The controller U1 at the output signal terminal GATE1 outputs the signal Vgs_Q1 to the gate terminal of the changeover switch Q1. The controller U1 at the output signal terminal GATE2 outputs the signal Vgs_Q2 to the gate terminal of the regulation switch Q2. The controller U1 receives a voltage from the voltage regulation unit 132. The controller U1 is coupled to the ground terminal at the ground terminal GND.

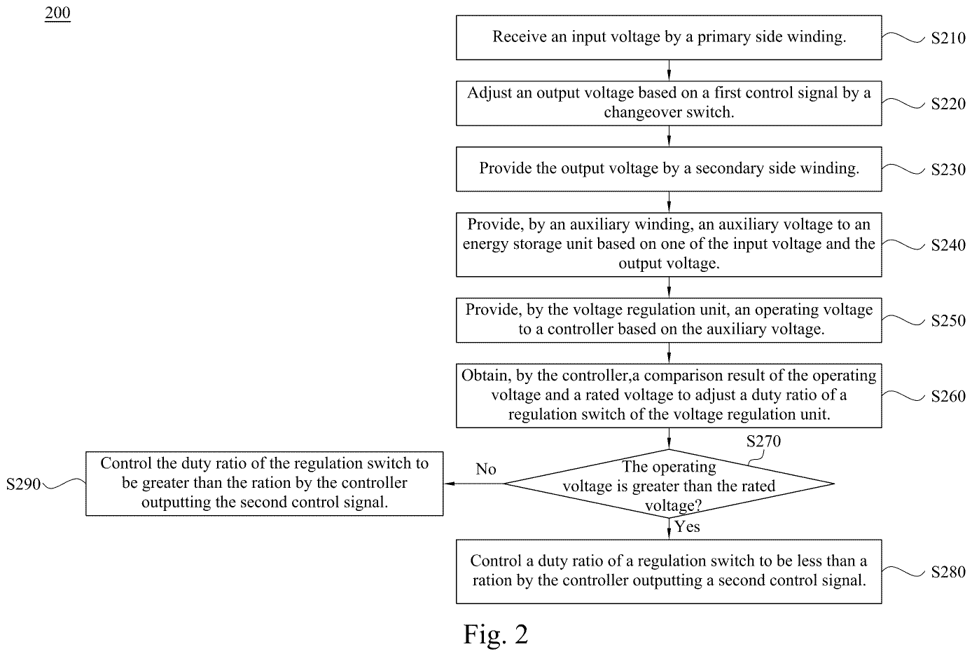

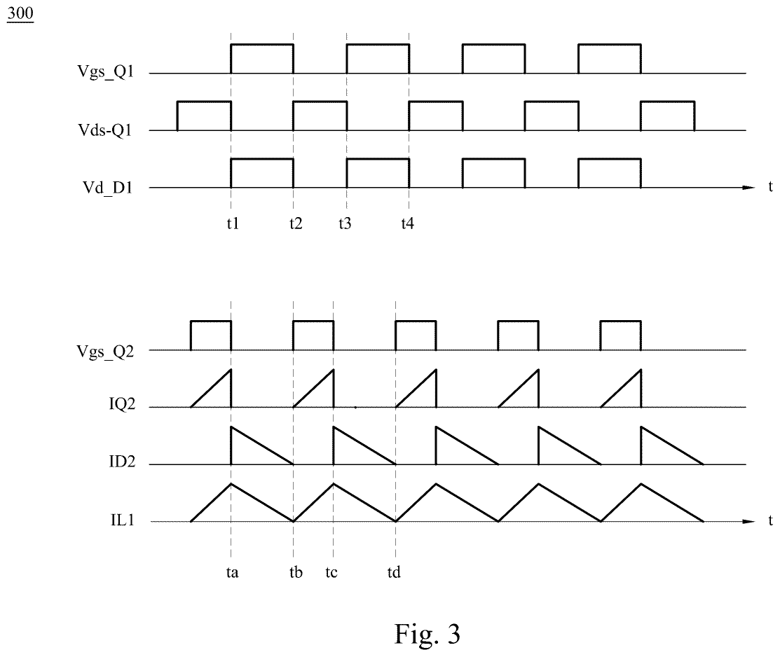

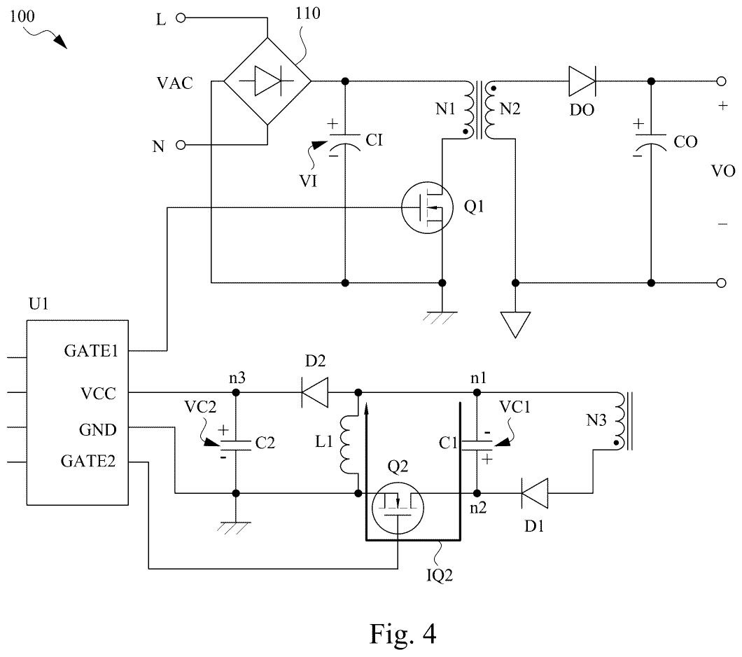

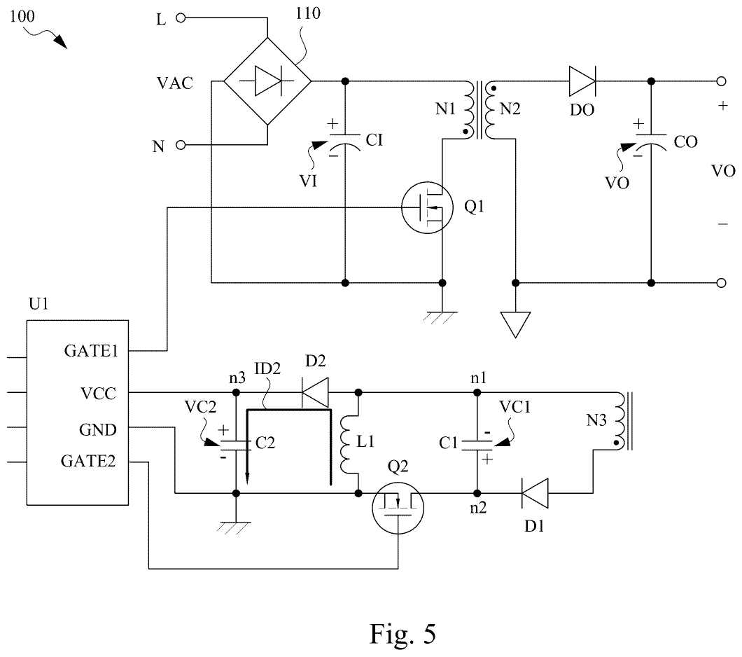

Please refer to FIG. 2, FIG. 3, and FIG. 4 to FIG. 5 together. FIG. 2 illustrates a flow chart of a controlling method 200 of the power converter 100 of FIG. 1, in accordance with one embodiment of the present disclosure. FIG. 3 illustrates a controlling timing diagram 300 of the power converter 100, in accordance with one embodiment of the present disclosure. FIG. 4 to FIG. 5 illustrate diagrams of operation of the power converter 100 of FIG. 1 during various periods, in accordance with one embodiment of the present disclosure. In some embodiments, the controller U1 performs the controlling method 200 to control the operation of the power converter 100.

In some embodiments, the signal Vgs_Q1 and the signal Vgs_Q2 are signals different from each other and no order of precedence in an operation relationship. Therefore, the controlling timing diagram 300 is only one embodiment of the present disclosure and not means that the signal Vgs_Q1 and the signal Vgs_Q2 must be the same signal or have the order of precedence in the operation relationship.

In some embodiments, time points t1 to t4 and time points ta to td represent different time. Specifically, an operation frequency of the signals Vgs_Q1 and Vd_D1 is much less than an operation frequency of the signal Vgs_Q2.

According to operation S210, the input capacitor CI is charged to an input voltage VI in response to a conversion voltage outputted by the bridge rectifier 110. The primary side winding N1 receives the input voltage VI from the input capacitor CI.

According to operation S220, from the time points t1 to t2, as shown in FIG. 3, the changeover switch Q1 is switched on in response to the signal Vgs_Q1 having high electric potential. At this time, the non-dotted terminal of the primary side winding N1 and the non-dotted terminal of the secondary side winding N2 are the high electric potential in response to the signal Vgs_Q1. Because the dotted terminal of the secondary side winding N2 is low electric potential, the diode DO is in the cut-off state. The secondary side winding N2 cannot charge the output capacitor CO.

In some embodiments, the diode DO is cut off in response to the positive terminal thereof having the low electric potential and the negative terminal thereof having the high electric potential. Specifically, the non-dotted terminal of the primary side winding N1 and the non-dotted terminal of the secondary side winding N2 are the high electric potential, so the positive terminal of the diode DO coupled to the dotted terminal of the secondary side winding N2 is the low electric potential, and the negative terminal of the diode DO is the high electric potential relatively, which makes the diode DO cut off.

In some embodiments, the auxiliary diode D1 is switched off in response to the positive terminal thereof having the low electric potential and the negative terminal thereof having the high electric potential. Specifically, the non-dotted terminal of the auxiliary winding N3 is the high electric potential in response to the non-dotted terminal of the primary side winding N1, so the positive terminal of the auxiliary diode D1 coupled to the dotted terminal of the auxiliary winding N3 is the low electric potential, and the negative terminal of the auxiliary diode D1 is the high electric potential relatively, which makes the auxiliary diode D1 cut off. At this time, the auxiliary diode D1 experiences the high voltage signal Vd_D1 generated by the reverse bias caused by the disconnection.

According to operation S230, from the time points t2 to t3, as shown in FIG. 3, the changeover switch Q1 is switched off in response to the signal Vgs_Q1 having the low electric potential. At this time, the dotted terminal of the primary side winding N1 and the dotted terminal of the secondary side winding N2 are the high electric potential in response to the signal Vgs_Q1. Because the dotted terminal of the secondary side winding N2 is the high electric potential, the diode DO is in the ON state. The secondary side winding N2 can charge the output capacitor CO.

In some embodiments, the diode DO is conducted in response to the positive terminal thereof having the high electric potential and the negative terminal thereof having the low electric potential. Specifically, the dotted terminal of the primary side winding N1 and the dotted terminal of the secondary side winding N2 are the high electric potential, so the positive terminal of the diode DO coupled to the dotted terminal of the secondary side winding N2 is the high electric potential, and the negative terminal of the diode DO is the low electric potential relatively, which makes the diode DO conducted.

In some embodiments, the auxiliary diode D1 is conducted in response to the positive terminal thereof having the high electric potential and the negative terminal thereof having the low electric potential. Specifically, the dotted terminal of the auxiliary winding N3 is the high electric potential in response to the dotted terminal of the secondary side winding N2, so the positive terminal of the auxiliary diode D1 coupled to the dotted terminal of the auxiliary winding N3 is the high electric potential, and the negative terminal of the auxiliary diode D1 is the low electric potential relatively, which makes the auxiliary diode D1 conducted.

According to operation S240, from the time points t2 to t3, as shown in FIG. 3, the auxiliary winding N3 supplies an auxiliary voltage VC1 to the energy storage unit 131 based on one of the input voltage VI and the output voltage VO.

In some embodiments, when a ratio of a maximum rated output voltage value and a minimum rated output voltage value of the output voltage VO is less than a ratio of a maximum rated input voltage value and a minimum rated input voltage value of the input voltage VI, the auxiliary winding N3 supplies the auxiliary voltage VC1 to the energy storage unit 131 based on the output voltage VO. Specifically, when a voltage variation range of the output voltage VO is 5 to 10V (with the ratio of 2 times) and a voltage variation range of the input voltage VI is 100 to 240V (with the ratio of 2.4 times), the auxiliary winding N3 supplies the auxiliary voltage VC1 to the auxiliary capacitor C1 based on the output voltage VO.

In some embodiments, the auxiliary voltage VC1 is based on an equation (1):

$$VC 1 = VO \times N 3 / N 2 \qquad ( 1 )$$

VC1 represents the auxiliary voltage VC1, VO represents the output voltage VO, N3 represents a number of turns of the auxiliary winding N3, and N2 represents a number of turns of the secondary side winding N2.

According to operation S250, in some embodiments, from the time points tb to tc, as shown in FIG. 3 and FIG. 4, the regulation switch Q2 is switched on in response to the signal Vgs_Q2 having the high electric potential. The auxiliary capacitor C1 charges the regulation inductor L1 by a current IQ2 flowing through the regulation switch Q2 and the regulation inductor L1. In some embodiments, a current IL1 and the current IQ2 are the same current at some time points.

According to operation S250, from the time points tc to td, as shown in FIG. 3 and FIG. 5, the regulation switch Q2 is switched off in response to the signal Vgs_Q2 having the low electric potential. The regulation inductor L1 charges the energy storage capacitor C2 by a current ID2 flowing through the regulation diode D2, which makes the energy storage capacitor C2 have the operating voltage VC2. The controller U1 receives the operating voltage VC2 at the receiving voltage terminal VCC. In some embodiments, the current IL1 and the current ID2 are the same current at some time points.

According to operation S260, a comparison result of the operating voltage VC2 and a rated voltage (the voltage required to drive the controller U1) is obtained by the controller U1 to adjust a duty ratio of the regulation switch Q2 of the voltage regulation unit 132.

In one embodiment, the power converter 100 has a detection circuit, in which the detection circuit (not shown in drawings) is configured to detect the operating voltage VC2.

In some embodiments, the power converter 100 has a comparison circuit (not shown in drawings) to determine whether the operating voltage VC2 is greater than the rated voltage based on operation S270. If yes, operation S280 is performed. If no, operation S290 is performed.

At the operation S280, the duty ratio of the regulation switch Q2 is controlled to be less than a ratio by the controller U1 outputting the signal Vgs_Q2.

For example, when the operating voltage VC2 is 10V, the rated voltage is 5V, and the controller U1 outputs the signal Vgs_Q2 to adjust the duty ratio of the regulation switch Q2 to be less than the ratio in response to the comparison result that the operating voltage VC2 is greater than the rated voltage.

At the operation S290, the duty ratio of the regulation switch Q2 is controlled to be greater than the ratio by the controller U1 outputting the signal Vgs_Q2.

For example, when the operating voltage VC2 is 3V, the rated voltage is 5V, and the controller U1 outputs the signal Vgs_Q2 to adjust the duty ratio of the regulation switch Q2 to be greater than the ratio in response to the comparison result that the operating voltage VC2 is less than the rated voltage.

In some embodiments, the ratio described at the operation S280 and S290 are a variable value because the duty ratio is changed with the output voltage VO.

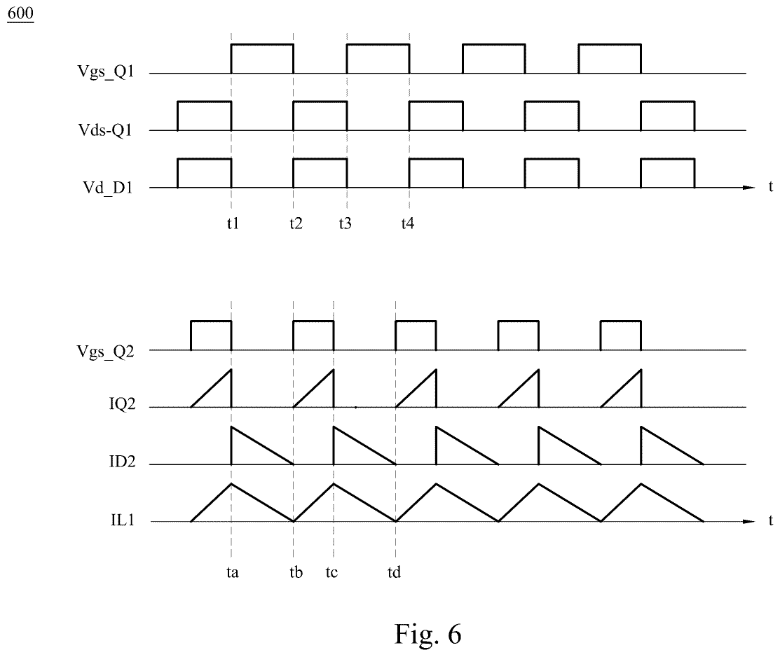

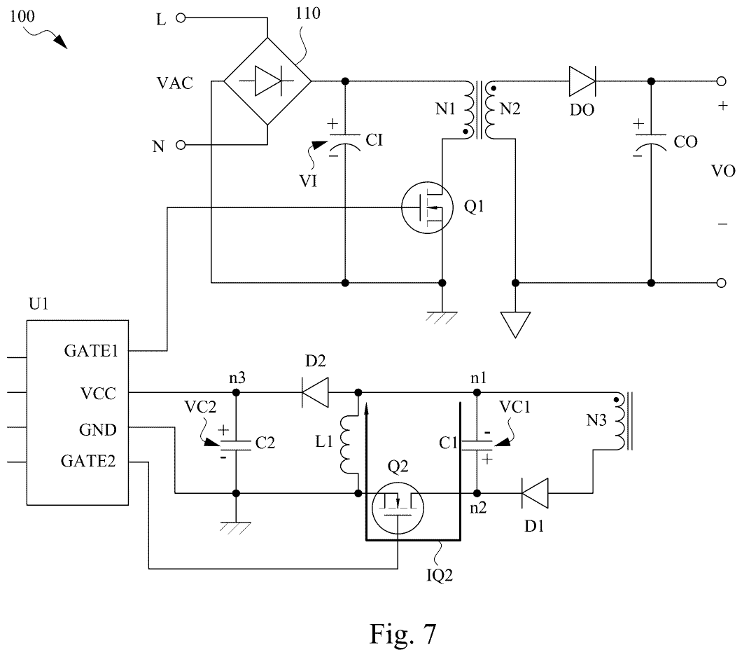

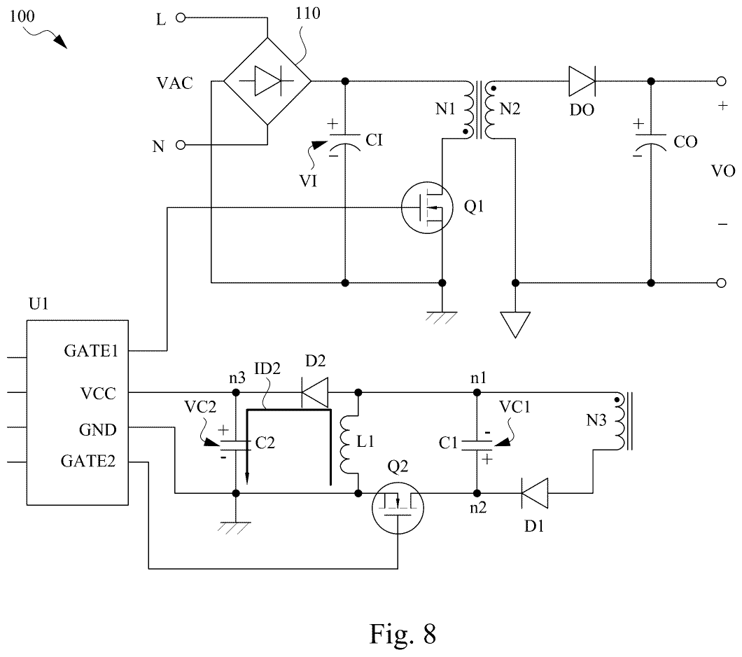

Please refer to FIG. 2, FIG. 6, and FIG. 7 to FIG. 8 together. FIG. 6 illustrates a controlling timing diagram 600 of the power converter 100, in accordance with one embodiment of the present disclosure. FIG. 7 to FIG. 8 illustrate diagrams of operation of the power converter 100 of FIG. 1 during various periods, in accordance with one embodiment of the present disclosure. Unless there is a need to illustrate a synergy of the elements, specific operations of similar elements, steps discussed, the specific operations of similar elements, which are already discussed in detail in above paragraphs, are omitted herein for the sake of brevity.

Please refer to FIG. 7 and FIG. 8. Compared to the power converter 100 of FIG. 1, FIG. 4, and FIG. 5, the dotted terminal of the auxiliary winding N3 is coupled to the node n1, and the non-dotted terminal of the auxiliary winding N3 is coupled to the positive terminal of the auxiliary diode D1.

As shown in FIG. 7, the auxiliary winding N3 and the primary side winding N1 are in the opposite direction (the dotted terminals in the opposite direction). The auxiliary winding N3 and the secondary side winding N2 are in the same direction (the dotted terminals in the same direction).

In some embodiments, the operations S230 and S240 are interchangeable.

According to operation S210, the input capacitor CI is charged to the input voltage VI in response to the conversion voltage outputted by the bridge rectifier 110. The primary side winding N1 receives the input voltage VI from the input capacitor CI.

According to the operation S220, from the time points t1 to t2, as shown in FIG. 6, the changeover switch Q1 is switched on in response to the signal Vgs_Q1 having the high electric potential. At this time, the non-dotted terminal of the primary side winding N1 and the non-dotted terminal of the secondary side winding N2 are the high electric potential in response to the signal Vgs_Q1. Because the dotted terminal of the secondary side winding N2 is the low electric potential, the diode DO is in the cut-off state. The secondary side winding N2 cannot charge the output capacitor CO.

In some embodiments, the auxiliary diode D1 is conducted in response to the positive terminal thereof having the high electric potential and the negative terminal thereof having the low electric potential. Specifically, the non-dotted terminal of the auxiliary winding N3 is the high electric potential in response to the non-dotted terminal of the primary side winding N1, so the positive terminal of the auxiliary diode D1 coupled to the non-dotted terminal of the auxiliary winding N3 is the high electric potential, and the negative terminal of the auxiliary diode D1 is the low electric potential relatively, which makes the auxiliary diode D1 conducted.

Continue with the operation S220, according to the operation S240, from the time points t1 to t2, as shown in FIG. 6, the auxiliary winding N3 supplies the auxiliary voltage VC1 to the energy storage unit 131 based on one of the input voltage VI and the output voltage VO.

In some embodiments, when the ratio of the maximum rated output voltage value and the minimum rated output voltage value of the output voltage VO is greater than the ratio of the maximum rated input voltage value and the minimum rated input voltage value of the input voltage VI, the auxiliary winding N3 supplies the auxiliary voltage VC1 to the energy storage unit 131 based on the input voltage VI. Specifically, when the voltage variation range of the output voltage VO is 5 to 15V (with the ratio of 3 times) and the voltage variation range of the input voltage VI is 100 to 240V (with the ratio of 2.4 times), the auxiliary winding N3 supplies the auxiliary voltage VC1 to the auxiliary capacitor C1 based on the input voltage VI.

In some embodiments, the auxiliary voltage VC1 is based on an equation (2):

$$VC 1 = VI \times N 3 / N 1 \qquad ( 2 )$$

VC1 represents the auxiliary voltage VC1, VI represents the input voltage VI, N3 represents the number of turns of the auxiliary winding N3, and N1 represents a number of turns of the primary side winding N1.

Continue with the operation S240, according to the operation S230. From the time points t2 to t3, as shown in FIG. 6, the changeover switch Q1 is switched off in response to the signal Vgs_Q1 having the low electric potential. At this time, the dotted terminal of the primary side winding N1 and the dotted terminal of the secondary side winding N2 are the high electric potential in response to the signal Vgs_Q1. Because the dotted terminal of the secondary side winding N2 is the high electric potential, the diode DO is in the ON state. The secondary side winding N2 can charge the output capacitor CO.

In some embodiments, the auxiliary diode D1 is cut off in response to the positive terminal thereof having the low electric potential and the negative terminal thereof having the high electric potential. Specifically, the dotted terminal of the auxiliary winding N3 is the high electric potential in response to the dotted terminal of the primary side winding N1, so the positive terminal of the auxiliary diode D1 coupled to the non-dotted terminal of the auxiliary winding N3 is the low electric potential, and the negative terminal of the auxiliary diode D1 is the high electric potential relatively, which makes the auxiliary diode D1 cut off. At this time, the auxiliary diode D1 experiences the high voltage signal Vd_D1 generated by the reverse bias caused by the disconnection.

Continue with the operation S230, according to the operation S250. In some embodiments, as shown in FIG. 6 and FIG. 7, from the time points tb to tc, the regulation switch Q2 is switched on in response to the signal Vgs_Q2 having the high electric potential. The auxiliary capacitor C1 charges the regulation inductor L1 by the current IQ2 flowing through the regulation switch Q2 and the regulation inductor L1. In some embodiments, the current IL1 and the current IQ2 are the same current at some time points.

According to the operation S250, from the time points tc to td, as shown in FIG. 6 and FIG. 8, the regulation switch Q2 is switched off in response to the signal Vgs_Q2 having the low electric potential. The regulation inductor L1 charges the energy storage capacitor C2 by the current ID2 flowing through the regulation diode D2, which makes the energy storage capacitor C2 have the operating voltage VC2. In some embodiments, the current IL1 and the current ID2 are the same current in some time points. The controller U1 receives the operating voltage VC2 at the receiving voltage terminal VCC.

According to operation S260, the comparison result of the operating voltage VC2 and the rated voltage (the voltage required to drive the controller U1) is obtained by the controller U1 to adjust the duty ratio of the regulation switch Q2 of the voltage regulation unit 132.

According to the operation S270, it determines whether the operating voltage VC2 is greater than the rated voltage. If yes, the operation S280 is performed. If no, the operation S290 is performed.

At the operation S280, the duty ratio of the regulation switch Q2 is controlled to be less than the ratio by the controller U1 outputting the signal Vgs_Q2.

At the operation S290, the duty ratio of the regulation switch Q2 is controlled to be greater than the ratio by the controller U1 outputting the signal Vgs_Q2.

In some embodiments, the ratio described at the operation S280 and S290 are the variable value because the duty ratio is changed with the input voltage VI.

In some embodiments, the duty ratio is based on an equation (3):

$$D = VCC / ( VCC + VC 1 ) \qquad ( 3 )$$

D represents the duty ratio, VCC represents the rated voltage, and VC1 represents the auxiliary voltage VC1.

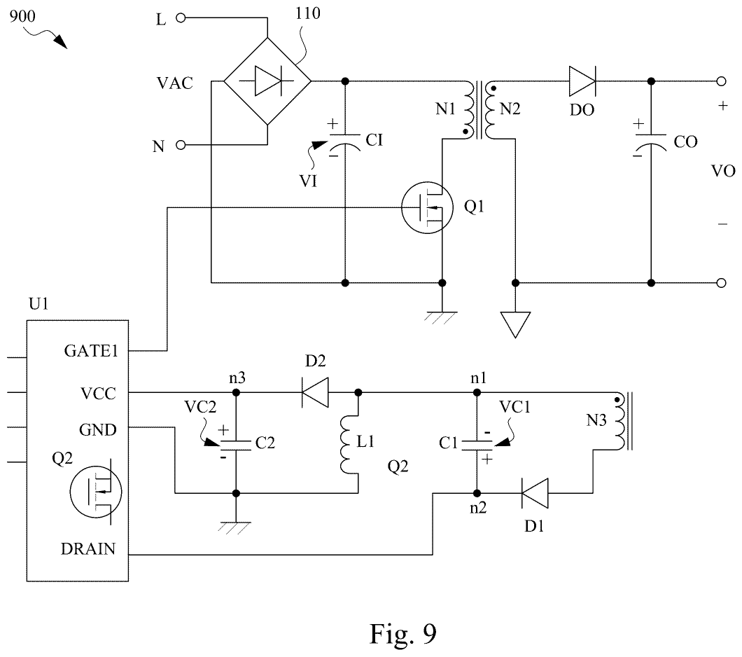

Please refer to FIG. 9. FIG. 9 illustrates a schematic diagram of a power converter 900, in accordance with one embodiment of the present disclosure. Compared to the power converter 100 of FIG. 1, the regulation switch Q2 can be coupled inside the controller U1. In other words, the regulation switch Q2 can be integrated in the controller U1.

In summary, the power converter and the controlling method thereof of the present disclosure control the duty ratio of the regulation switch based on the ratio of the output voltage and the rated voltage of driving the controller to adjust the voltage supplied to the controller from the auxiliary winding for avoiding extreme power consumption and meeting increasingly stringent energy efficiency regulations.

Although the present disclosure has been described above with reference to the embodiments, it is not intended to limit the scope of the present disclosure. Various modifications and refinements may be made by those skilled in the art without departing from the spirit and scope of the present disclosure. Therefore, the scope of protection of the present disclosure shall be defined by the appended claims.

What is claimed is:

1. A power converter, comprising:
a conversion circuit, comprising:
a changeover switch configured to adjust an output voltage based on a first control signal; and
a magnetic component, comprising:
a primary side winding coupled to the changeover switch and configured to receive an input voltage; and
a secondary side winding configured to provide the output voltage;
an auxiliary circuit, comprising:
an auxiliary winding magnetically coupled to the magnetic component and configured to provide an auxiliary voltage;
an energy storage unit configured to store the auxiliary voltage; and
a voltage regulation unit coupled to the auxiliary winding and the energy storage unit in parallel and configured to receive the auxiliary voltage and provide an operating voltage; and
a controller configured to receive the operating voltage from the voltage regulation unit.

2. The power converter of claim 1, wherein the auxiliary winding and the primary side winding are in a same direction, and the auxiliary winding and the secondary side winding are in an opposite direction.

3. The power converter of claim 2, wherein the energy storage unit comprises:
an auxiliary capacitor coupled to a non-dotted terminal of the auxiliary winding; and
an auxiliary diode coupled between a dotted terminal of the auxiliary winding and the auxiliary capacitor.

4. The power converter of claim 3, wherein the voltage regulation unit, comprises:
a regulation inductor;
a regulation switch, wherein a first terminal of the regulation switch is coupled between the auxiliary capacitor and the auxiliary diode, a second terminal of the regulation switch is coupled between the regulation inductor and a ground terminal, and a third terminal of the regulation switch is coupled to the controller; and
a regulation diode, wherein a first terminal of the regulation diode is coupled between the regulation inductor, the auxiliary capacitor, and the auxiliary winding, and a second terminal of the regulation diode is coupled to an input terminal of the controller configured to receive the operating voltage.

5. The power converter of claim 4, wherein the auxiliary circuit further comprises an energy storage capacitor, wherein the energy storage capacitor is coupled between the input terminal and the regulation diode.

6. The power converter of claim 4, wherein:
when the operating voltage is greater than a rated voltage, the controller controls, based on a second control signal, a duty ratio of the regulation switch to be less than a ratio; and
when the operating voltage is less than the rated voltage, the controller controls, based on the second control signal, the duty ratio to be greater than the ratio, wherein the first control signal and the second control signal are different from each other.

7. The power converter of claim 1, wherein the auxiliary winding and the primary side winding are in an opposite direction, and the auxiliary winding and the secondary side winding are in a same direction.

8. The power converter of claim 7, wherein the energy storage unit, comprises:
an auxiliary capacitor coupled to a dotted terminal of the auxiliary winding; and
an auxiliary diode coupled between a non-dotted terminal of the auxiliary winding and the auxiliary capacitor.

9. The power converter of claim 8, wherein:
when the changeover switch is switched on, the auxiliary diode is conducted, and the auxiliary winding charges the auxiliary capacitor; and
when the changeover switch is switched off, the auxiliary diode is cut off, and the auxiliary winding does not charge the auxiliary capacitor.

10. The power converter of claim 8, wherein the voltage regulation unit, comprises:
a regulation inductor;
a regulation switch, wherein a first terminal of the regulation switch is coupled between the auxiliary capacitor and the auxiliary diode, a second terminal of the regulation switch is coupled between the regulation inductor and a ground terminal, and a third terminal of the regulation switch is coupled to the controller; and
a regulation diode, wherein a first terminal of the regulation diode is coupled between the regulation inductor, the auxiliary capacitor, and the auxiliary winding, and a second terminal of the regulation diode is coupled to a input terminal of the controller, wherein the input terminal is configured to receive the operating voltage.

11. The power converter of claim 10, wherein the auxiliary circuit further comprises an energy storage capacitor, wherein the energy storage capacitor is coupled between the controller and the regulation diode.

12. The power converter of claim 10, wherein:
when the operating voltage is greater than a rated voltage, the controller controls, based on a second control signal, a duty ratio of the regulation switch to be less than a ratio; and
when the operating voltage is less than the rated voltage, the controller controls, based on the second control signal, the duty ratio to be greater than the ratio, wherein the first control signal and the second control signal are different from each other.

13. The power converter of claim 8, wherein the voltage regulation unit, comprises:
a regulation inductor; and
a regulation diode, wherein a first terminal of the regulation diode is coupled to the regulation inductor, and a second terminal of the regulation diode is coupled to a input terminal of the controller, wherein the input terminal is configured to receive the operating voltage;
wherein the controller comprises:
a regulation switch, wherein the controller controls, based on a rated voltage and a second control signal, a duty ratio of the regulation switch.

14. The power converter of claim 13, wherein a withstand voltage of the changeover switch is greater than a withstand voltage of the regulation switch.

15. A controlling method of a power converter, wherein the power converter comprises a conversion circuit having a changeover switch and a magnetic component, an auxiliary circuit having an auxiliary winding, an energy storage unit, and a voltage regulation unit coupled to the auxiliary winding and the energy storage unit in parallel, and a controller, wherein the magnetic component comprises a primary side winding and a secondary side winding, wherein the method comprises:
receiving an input voltage by the primary side winding;
adjusting an output voltage based on a first control signal by the changeover switch;
providing the output voltage by the secondary side winding;
providing, by the auxiliary winding, an auxiliary voltage to the energy storage unit based on one of the input voltage and the output voltage ;
providing, by the voltage regulation unit, an operating voltage to the controller based on the auxiliary voltage; and
obtaining, by the controller, a comparison result of the operating voltage and a rated voltage to adjust a duty ratio of a regulation switch of the voltage regulation unit.

16. The controlling method of claim 15, further comprising:
when the comparison result is that the operating voltage is greater than the rated voltage, controlling, by the controller, the duty ratio of the regulation switch to be less than a ratio based on a second control signal.

17. The controlling method of claim 15, further comprising:
when the comparison result is the operating voltage less than the rated voltage, controlling, by the controller, the duty ratio of the regulation switch to be greater than a ratio based on a second control signal.

18. The controlling method of claim 15, further comprising:
when the auxiliary winding and the primary side winding are in a same direction and the auxiliary winding and the secondary side winding are in an opposite direction, providing, by the auxiliary winding, the auxiliary voltage to the energy storage unit based on the output voltage.

19. The controlling method of claim 18, further comprising:
when the changeover switch is switched off, charging, by the auxiliary winding, an auxiliary capacitor included in the auxiliary circuit.

20. The controlling method of claim 15, further comprising:
when the auxiliary winding and the primary side winding are in an opposite direction and the auxiliary winding and the secondary side winding are in a same direction, providing, by the auxiliary winding, the auxiliary voltage to the energy storage unit based on the input voltage; and
when the changeover switch is switched on, charging an auxiliary capacitor included in the auxiliary circuit by the auxiliary winding.
